(19) United States
(12) Patent Application Publication
(10) Pub. No.: US 2008/0252940 A1
(43) Pub. Date: Oct. 16, 2008

(54) IMAGE SCANNER AND CONTROL METHOD THEREOF

(75) Inventor: Shinji Koizumi, Mishima-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/733,954

(22) Filed: Apr. 11, 2007

(51) Int. Cl. H04N 1/21

(52) U.S. Cl. 358/474

(57) ABSTRACT

An image scanner according to the invention is an image scanner that can save scanned image data in a removable portable memory, the image scanner including a storing unit, a key-file creating unit that creates a key file corresponding to the portable memory, a memory control unit that registers the key file created in the storing unit and saves the key file in the portable memory, a determining unit that performs, before the image data is saved in the portable memory, matching of the key file registered in the storing unit and the key file saved in the portable memory, and an image-data-saving control unit that saves the image data in the portable memory when match is determined by the determining unit.

### BACKGROUND OF THE INVENTION

1. Field of the Invention

The present invention relates to an image scanner and a control method thereof, and, more particularly to an image scanner that can save scanned image data in a portable memory such as a USB memory and a control method thereof.

2. Description of the Related Art

Recently, a storage capacity of a nonvolatile semiconductor memory such as a flash memory has been rapidly increasing. In response to the increase in the memory capacity, various portable memories having a small size and weight and a large capacity have appeared. For example, portable memories such as a USB flash memory, an SD memory card, a compact flash, and a memory stick are circulated in the market. Further, in the field of a hard disk that has been famous for its large capacity, an HDD (Hard disk drive) that has a small size and low power consumption has been realized and has appeared as a portable memory applicable to a USB and the like.

According to the spread of these portable memories, in image scanning apparatuses such as a scanner apparatus and an MFP (Multi-Function Peripheral) having a scanning function, it is possible to transfer scanned image data to an externally-connected portable memory and save the image data therein with simple operation.

Anybody can save data in the portable memories with simple operation and easily carry the portable memories, but on the other hand, it is highly likely that important data is illegally extracted. Therefore, in apparatus in which the portable memories can be used, it is an important issue to ensure security.

For example, JP-A 2002-300298 discloses a technique for, in a mobile radio terminal apparatus such as a cellular phone in which a memory card can be inserted, registering peculiar identification information held by the memory card in an internal memory of the mobile radio terminal apparatus in advance and permitting saving of data only in the memory card registered.

It is possible to prevent scanned image data from being illegally extracted to some extent by applying this technique to the image scanning apparatuses.

However, the image scanning apparatuses such as the scanner apparatus and the MFP are apparatuses used by a large number of users in places of work unlike apparatuses such as the cellular phone that are provided on the assumption that the apparatuses are used by individuals. Therefore, for example, when a portable memory is lost and passed into a third party's hand or when a portable memory is stolen, even if identification information peculiar to the portable memory is registered in advance, it is likely that the portable memory is illegally used easily.

Since extremely highly confidential data could be included in image data scanned by the image scanning apparatuses, it is necessary to ensure higher security when the portable memory is used.

### SUMMARY OF THE INVENTION

The present invention has been devised in view of the circumstances and it is an object of the invention to provide an image scanner that can save scanned image data in a portable memory, the image scanner being capable of realizing ensuring of high security and preventing illegal use of the portable memory, and a control method of the image scanner.

In order to attain the object, an image scanner according to an aspect of the invention is an image scanner that can save scanned image data in a removable portable memory, the image scanner including a storing unit, a key-file creating unit that creates a key file corresponding to the portable memory, a memory control unit that registers the key file created in the storing unit and saves the key file in the portable memory, a determining unit that performs, before the image data is saved in the portable memory, matching of the key file registered in the storing unit and the key file saved in the portable memory, and an image-data-saving control unit that saves the image data in the portable memory when match is determined by the determining unit.

In order to attain the object, a control method of an image scanner according to another aspect of the invention is a control method of an image scanner that can save scanned image data in a removable portable memory, the control method including the steps of (a) creating a key file corresponding to the portable memory, (b) registering the key file created in a storing unit and saving the key file in the portable memory, (c) performing, before the image data is saved in the portable memory, matching of the key file registered in the storing unit and the key file saved in the portable memory, and (d) saving the image data in the portable memory when it is determined that the key files match.

### BRIEF DESCRIPTION OF THE DRAWINGS

In the accompanying drawings:

FIG. 1 is a diagram showing an example of a structure of an image scanner according to a first embodiment of the invention;

FIG. 2 is a flowchart showing an example of processing for registering a portable memory;

FIGS. 3A and 3B are flowcharts showing an example of processing for saving image data in the portable memory; and

FIG. 4 is a diagram showing an example of a structure of an image scanner according to a second embodiment of the invention.

### DETAILED DESCRIPTION OF THE PREFERRED EMBODIMENTS

Embodiments of an image scanner and a control method thereof according to the invention will be explained with reference to the accompanying drawings.

### (1) Structure of an Image Scanner

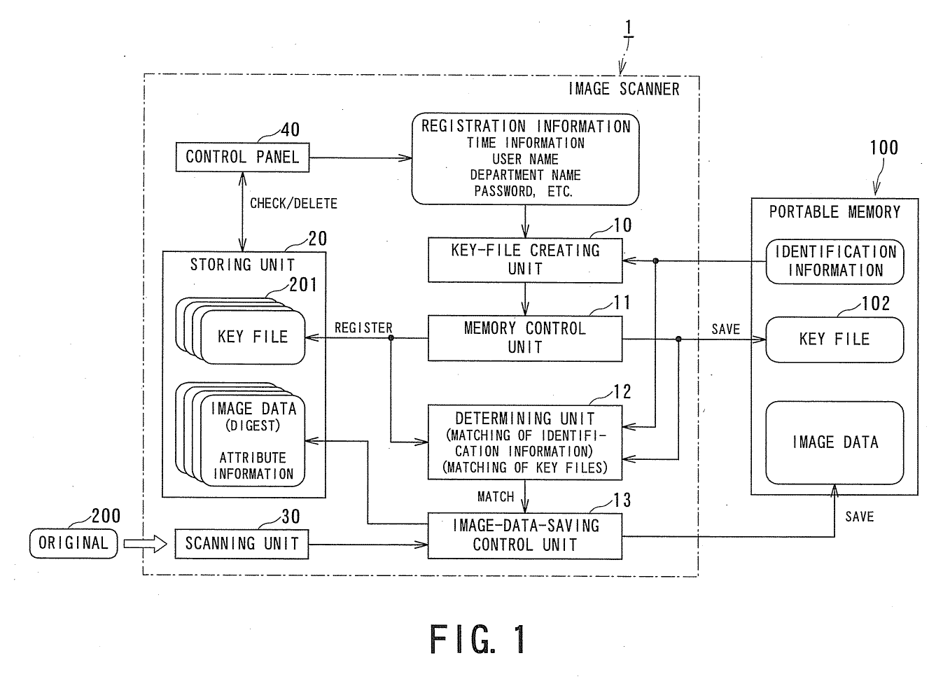

FIG. 1 is a diagram showing an example of a structure of an image scanner 1 according to an embodiment of the invention. The image scanner 1 is an apparatus constituted as a scanner exclusive for original scanning or an original scanning unit of a copying machine or an MFP (Multi-Function Peripheral).

The image scanner 1 is constituted by including a key-file creating unit 10, a storing unit 20, a scanning unit 30, a memory control unit 11, a determining unit 12, an image-data-saving control unit 13, a control panel 40, and the like.

The image scanner 1 is constituted such that a portable memory 100 can be inserted in and removed from the image scanner 1. A type of the portable memory 100 is not specifically limited. The portable memory 100 is, for example, a nonvolatile semiconductor memory such as a USB flash memory, an SD memory card, a compact flash, or a memory stick. Further, the portable memory 100 is, for example, an external storage device incorporating an HDD (Hard disk drive) that has a small size and low power consumption.

The portable memory 100 is inserted in the image scanner 1 when image data is saved therein and removed from the image scanner 1 after the saving of the image data to make it possible to freely carry the image data saved.

The scanning unit 30 incorporates, for example, a CCD sensor (not shown), optically scans an original 200, and converts the original 200 into image data. This image data is saved in the portable memory 100 under the control by the image-data-saving control unit 13. Prior to the saving, correctness of the portable memory 100 (which means that the portable memory 100 is the portable memory 100 regularly registered and is not a counterfeit) is determined by the determining unit 12. Only when it is determined by the determining unit 12 that the portable memory 100 inserted in the image scanner 1 is correct, the image-data-saving control unit 13 permits saving of the image data in the portable memory 100.

The determination on correctness of the portable memory 100 performed by the determining unit 12 is performed according to collation of a key file 102 saved in the portable memory 100 at the time of registration of the portable memory 100 and a key file 201 registered in the storing unit 20 of the image scanner 1 simultaneously with the saving of the key file 102.

The key-file creating unit 10 reads out identification information from the portable memory 100 inserted therein. Usually, in the portable memory 100, manufacturer identification information, product identification information, a serial number, and the like are recorded in a predetermined area as identification information of the portable memory 100. This identification information is read by the image scanner 1 and, then, the key files 102 and 201 are created on the basis of the identification information read.

It is preferable from the viewpoint of prevention of information manipulation to include, in information forming a basis of the key files 102 and 201, registration information in registering the portable memory 100 in addition to the identification information of the portable memory 100.

As the registration information, there are time information at the time of registration, a user name, a department name, and a password of a registrant (a regular user) of the portable memory 100, and the like. The time information at the time of registration is automatically obtained from a timer (RTC: Real Time Clock) incorporated in the image scanner 1. The user name, the department name, and the password of the registrant are obtained from information input by the registrant from a control panel 40.

In the following description, explanations will be made assuming that the key files 102 and 201 are created on the basis of both the identification information and the registration information.

The key-file creating unit 10 converts the identification information and the registration information into information decodable by only the image scanner 1 and creates a key file. For example, the image scanner 1 encrypts the identification information and the registration information read using an encryption key originally created by the image scanner 1 and sets the identification information and the registration information as the key files 102 and 201.

The memory control unit 201 saves the key file 102 created in the portable memory 100 and registers the key file 201 of the same contents in the storing unit 20 of the image scanner 1. The storing unit 20 is a nonvolatile storage device, for example, an HDD (Hard Disk Drive).

The key file 201 registered in the storing unit 20 is formed such that an administrator of the image scanner 1 can delete the key file 201. When the regular user of the portable memory 100 has lost the portable memory 100 or has the portable memory 100 stolen, the user notifies the administrator to that effect and the administrator deletes the key file 201 corresponding to the portable memory 100.

After the key file 201 is deleted, since matching of the key files 102 and 201 cannot be performed by the determining unit 12, saving of scanned data in the lost or stolen portable memory 100 is prohibited. Thus, it is possible to prevent the image data from being illegally extracted.

Besides the key file 201, a part or all of the image data saved in the portable memory 100 are saved in the storing unit 20. As attribute information at the time of saving, it is advisable to also save time information of the time when an original is read, a user name, and the like. When it is found out that the image data is illegally extracted by the portable memory 100, the administrator or the like is capable of specifying which data is illegally extracted and when the data is illegally extracted with reference to the image data and the attribute information saved in the storing unit 20. Consequently, it is possible to minimize damage due to the illegal extraction of the data. The image data saved in the storing unit 20 only has to be data sufficient for specifying the image data extracted by the portable memory 100. It is not always necessary to save all image data saved in the portable memory 100. For example, the image data may be only the part of a front cover with which a scanned original can be specified or may be an image, a quality of which is degraded by compression processing. Consequently, it is possible to save a storage capacity of the storing unit 20.

### (2) Control Method of the Image Scanner

A control method of the image scanner 1 constituted as described above, in particular, processing at the time of registration of the portable memory 100 and processing in saving image data in the portable memory 100 will be explained.

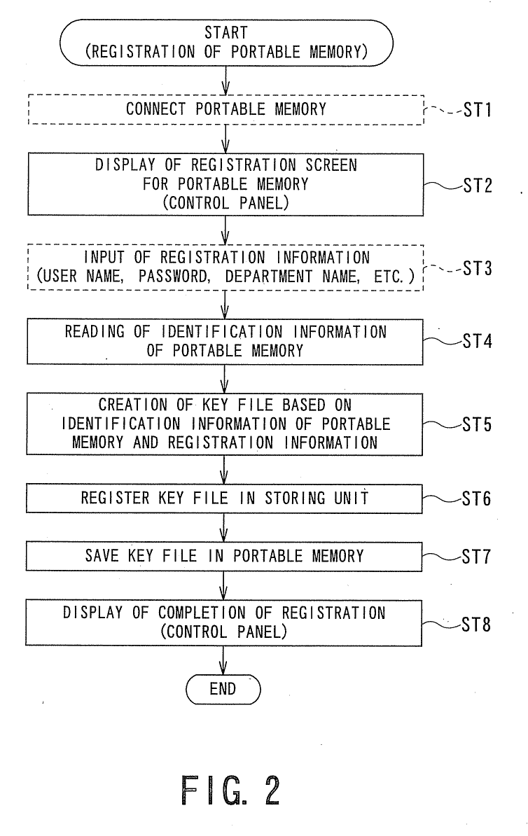

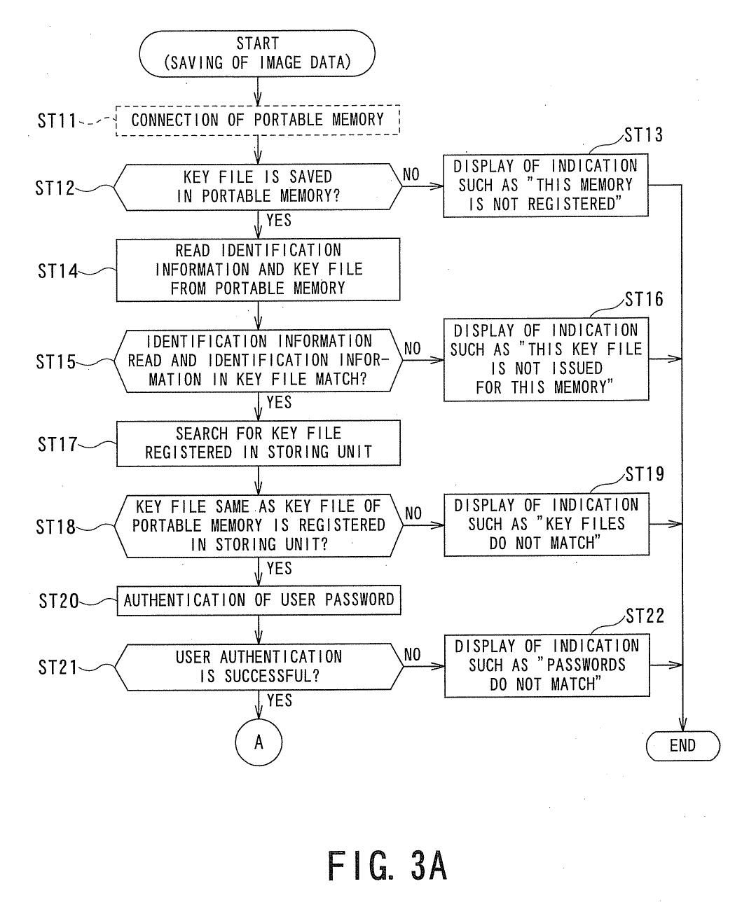

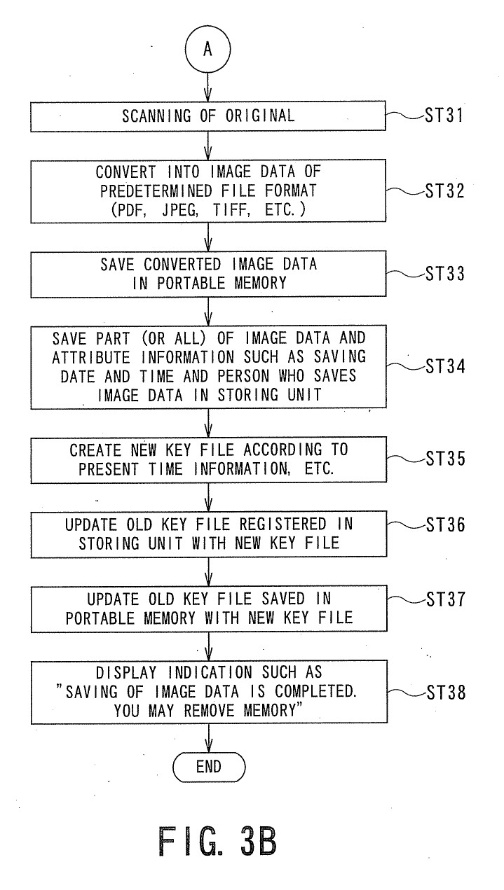

FIG. 2 is a flowchart showing an example of the processing at the time of registration of the portable memory 100. In FIG. 2, parts enclosed by broken lines indicate operation by the user (the same applies in FIG. 3A).

First, the user (the regular owner of the portable memory 100) inserts an unused portable memory 100 in the image scanner 1 and connects the portable memory 100 to the image scanner 1 (step ST1).

The image scanner 1 detects that the portable memory 100 is connected thereto and displays a registration screen on the control panel 40 (step ST2).

The user inputs registration information such as a user name, a department name, and a password to the registration screen of the control panel 40 (step ST3).

Subsequently, the image scanner 1 reads identification information held by the portable memory 100 (step ST4).

The image scanner 1 encrypts registration information (the registration information input by the user and time information automatically acquired from the RTC (real time clock) incorporated in the image scanner 1) and the identification information read with an encryption key and creates the key files 102 and 201 (step ST5).

The image scanner 1 registers the key file 201 created in the storing unit 20 (step ST6) and saves the key file 102 of the same contents in the portable memory 100 (step ST7). Finally, the image scanner 1 displays an indication that the registration of the portable memory 100 is completed on the control panel 40 (step ST8) and finishes the registration processing.

FIGS. 3A and 3B are diagrams showing an example of processing for saving image data scanned by the image scanner 1 in the portable memory 100.

First, the user (including a third party who is not the regular holder) inserts the portable memory 100 in the image scanner 1 and connects the portable memory 100 thereto (step ST11)

The determining unit 12 of the image scanner 1 accesses the portable memory 100 connected to the image scanner 1 and determines whether the key file 102 is saved in the portable memory 100 (step ST12).

As described above, in the registration of the portable memory 100, the image scanner 1 registers the key file 201 in the storing unit 20 in the image scanner 1 and saves the key file 102 of the same contents in the portable memory 100. Therefore, when the key file 102 is not saved in the portable memory 100, this means that the portable memory 100 is not registered. Thus, when the key file 102 is not saved in the portable memory 100 (NO in step ST12), the image scanner 1 displays an indication such as “This memory is not registered” on the control panel 40 (step ST13) and finishes the processing.

When the key file 102 is registered in the portable memory 100, the image scanner 1 reads the key file 102. The image scanner 1 also reads the identification information held by the portable memory 100 (step ST14).

Subsequently, the image scanner 1 decodes the key file 102 using the encryption key used at the time of registration and extracts the identification information included in the key file 102. The image scanner 1 determines whether the identification information extracted and the identification information read from the portable memory 100 inserted in the image scanner 1 at present match (step ST15).

When the key file 102 of the portable memory 100 registered is illegally copied and saved in “another portable memory”, i.e., when the portable memory 100 is counterfeited, identification information held by the “another portable memory” and the identification information included in the key file 102 do not match. According to the determination in step ST15, it is possible to detect presence or absence of illegal copy of the key file 102. When the identification information of the key file 102 and the identification information of the present portable memory 100 do not match, it is highly likely that illegal copy of the key file 102 is performed. Thus, the image scanner 1 displays an indication such as “This key file is not issued for this memory” on the control panel 40 (step ST16) and finishes the processing.

Subsequently, the imaging scanner 1 searches through the storing unit 20 and determines whether the key file 201 of the same content matching the contents of the key file 102 read is registered (step ST18). According to this determination, the imaging scanner 1 can also check whether the portable memory 100 connected thereto at present is the portable memory 100 regularly registered.

As described above, when loss or theft of the portable memory 100 occurs, the administrator of the image scanner 1 can delete the key file 201 registered in the storing unit 20. When the regular holder of the portable memory 100 notices the loss or the theft, the holder notifies the administrator to that effect. The key file 201 of the portable memory 100 is deleted. As a result, according to the determination processing in step ST18, it is possible to prevent the portable memory 100 lost or stolen from being used. When the key file 201 matching the key file 102 read is not registered in the storing unit 20 at that point (NO in step ST18), the image scanner 1 displays an indication such as “The key file does not match” on the control panel 40 (step ST19) and finishes the processing.

Moreover, user authentication by a password may be performed. Even if the registered portable memory 100 is passed into an illegal third party's hand because of loss or theft, while the regular holder does not notice the loss or the theft, the key file 201 registered in the storing unit 20 is not deleted. In this case, the third party manages to get around the determination in step ST18. By performing the user authentication by a password, it is possible to eliminate the use of the portable memory 100 by a third party who does not know the password.

Steps ST20 and ST21 are processing of the user authentication. When the third party has failed in the user authentication, the image scanner 1 displays an indication such as “The password does not match” on the control panel 40 (step ST22) and finishes the processing.

Success of the user authentication in step ST21 means that it is verified with a high probability that the portable memory 100 connected to the image scanner 1 is regularly registered and the portable memory 100 is used by the regular user. AT this stage, the image scanner 1 is permitted to save the scanned image data in the portable memory 100 and proceeds to step ST31 in FIG. 3B.

In step ST31, the scanning unit 30 of the image scanner 1 scans the original 200. The image scanner 1 converts a scanned image into image data of a predetermined file format, for example, a file format of PDF, JPEG, or TIFF (step ST32). Thereafter, the image scanner 1 saves the image data converted in the portable memory 100 (step ST33).

On the other hand, the image scanner 1 registers a part or all of image data same as the image data saved in the portable memory 100 and attribute information such as a saving date and time and a user (a person who saves the image data) in the storing unit 20. If illegal extraction of image data by the portable memory 100 occurs, the administrator is capable of specifying when and what kind of image data is extracted with reference to this information registered in the storing unit 20. As a result, it is possible to minimize damage due to the illegal extraction.

The next steps ST35, ST36, and ST37 are processing for updating the key files 102 and 201. In this embodiment, rather than simply registering only the authentication information of the portable memory 100, the key files 102 and 201 are generated on the basis of information obtained by adding registration information to the authentication information and registering and saving the information in both the image scanner 1 and the portable memory 100. Therefore, compared with the method of registering only the authentication information, it is more difficult to counterfeit the portable memory 100. However, it is impossible to completely exclude the likelihood that the authentication information and the key file 102 are counterfeited.

Thus, the key files 102 and 201 are updated to new files every time image data is saved. Consequently, even if the portable memory 100 is counterfeited, the portable memory 100 is prevented from being repeatedly used.

When the key files 102 and 201 are updated for the regular portable memory 100, it is impossible to use the counterfeit portable memory 100. Conversely, when the key files 102 and 201 are updated for the counterfeit portable memory 100, it is impossible to use the regular portable memory 100. Thus, it is possible to find out at that point that illegal use by the counterfeit portable memory 100 has been performed and take appropriate measures.

Specifically, in step ST35, the image scanner 1 creates new key files 102 and 201 including present time information as a part of registration information. The image scanner 1 updates the old key file 201 registered in the storing unit 20 (step ST36) and updates the old key file 102 saved in the portable memory 100 using this new key files 102 and 201.

With the method of reading the identification information of the portable memory 100 and registering only the identification information, it is impossible in the first place to update registered contents to new ones every time image data is saved. Therefore, once the portable memory 100 is counterfeited, it is likely that the counterfeit portable memory 100 is used for a long period.

Finally the image scanner 1 displays an indication such as “Saving of the image data is completed. You may remove the memory” on the control panel 40 and finishes the processing for saving the image data.

### (3) Second Embodiment

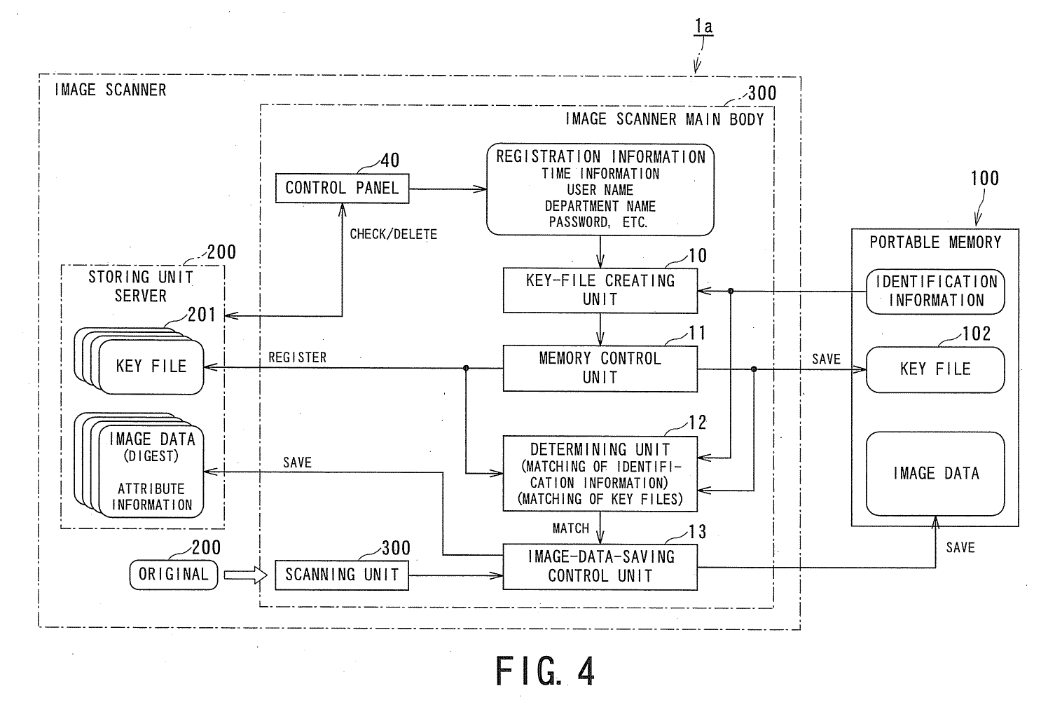

FIG. 4 is a diagram showing an example of a structure of an image scanner 1a according to a second embodiment. The image scanner 1 according to the first embodiment registers the key file 201, the image data, and the attribute information in the storing unit 20 in the inside of the image scanner 1. On the other hand, the image scanner 1a according to the second embodiment includes an image scanner main body 300 equivalent to the image scanner 1 in the first embodiment and a storage server 200 provided outside the image scanner main body 300. The second embodiment is different from the first embodiment in that the functions of the storing unit 20 in the first embodiment are realized by the storage server 200. However, the other components and functions are the same as those in the first embodiment. Thus, detailed explanations of the second embodiment are omitted.

As explained above, according to the image scanner 1 and the control method thereof according to the embodiments, in the image scanner 1 that can save scanned image data in the portable memory 100, it is possible to realize ensuring of high security when the image data is saved and prevent illegal use of the portable memory 100.

The present invention is not limited to the embodiments per se. At an implementation stage, it is possible to modify and embody the elements without departing from the spirit of the invention. It is also possible to form various embodiments of the invention according to appropriate combinations of the plural elements disclosed in the embodiments. For example, several elements may be deleted from all the elements described in the embodiments. Moreover, elements described in different embodiments may be appropriately combined.

What is claimed is:

1. An image scanner that can save scanned image data in a removable portable memory, the image scanner comprising:
a storing unit;
a key-file creating unit that creates a key file corresponding to the portable memory;
a memory control unit that registers the key file created in the storing unit and saves the key file in the portable memory;
a determining unit that performs, before the image data is saved in the portable memory, matching of the key file registered in the storing unit and the key file saved in the portable memory; and
an image-data-saving control unit that saves the image data in the portable memory when match is determined by the determining unit.

2. An image scanner according to claim 1, wherein the key-file creating unit reads out identification information peculiar to the portable memory saved in the portable memory in advance and creates the key file on the basis of the identification information read out.

3. An image scanner according to claim 2, wherein the determining unit further performs matching of the identification information saved in the portable memory in advance and the identification information included in the key file.

4. An image scanner according to claim 2, wherein the key-file creating unit creates the key file on the basis of registration information including time information at the time when the key file is created and the identification information.

5. An image scanner according to claim 1, wherein, when the image data is saved in the portable memory,
the key-file creating unit creates the key file anew, and
the memory control unit updates a key file in the past registered in the storing unit and updates a key file in the past saved in the portable memory with the key file created anew.

6. An image scanner according to claim 4, wherein, when the image data is saved in the portable memory,
the key-file creating unit creates the key file anew, and
the memory control unit updates a key file in the past registered in the storing unit and updates a key file in the past saved in the portable memory with the key file created anew.

7. An image scanner according to claim 1, wherein the memory control unit is constituted to be capable of deleting the key file registered in the storing unit on the basis of an instruction from an outside.

8. An image scanner according to claim 1, wherein the image-data-saving control unit saves the image data in the portable memory and saves at least a part of contents of the image data and attribute information at the time of the saving in the storing unit.

9. An image scanner according to claim 1, wherein the image-data-saving control unit performs user authentication when the image data is saved in the portable memory and, when match is determined by the determining unit and the user authentication is successful, saves the image data in the portable memory.

10. A control method of an image scanner that can save scanned image data in a removable portable memory, the control method comprising the steps of:
a) creating a key file corresponding to the portable memory;
(b) registering the key file created in a storing unit and saving the key file in the portable memory;
(c) performing, before the image data is saved in the portable memory, matching of the key file registered in the storing unit and the key file saved in the portable memory; and
(d) saving the image data in the portable memory when it is determined that the key files match.

11. A control method of an image scanner according to claim 10, wherein, in step (a), identification information peculiar to the portable memory saved in the portable memory in advance is read out and the key file is created on the basis of the identification information read out.

12. A control method of an image scanner according to claim 11, further comprising the step of, in step (c), performing matching of the identification information saved in the portable memory in advance and the identification information included in the key file.

13. A control method of an image scanner according to claim 11, wherein, in step (a), the key file is created on the basis of registration information including time information at the time when the key file is created and the identification information.

14. A control method of an image scanner according to claim 10, further comprising the steps of, when the image data is saved in the portable memory in step (d):
creating the key file anew; and
updating a key file in the past registered in the storing unit and updating a key file in the past saved in the portable memory with the key file created anew.

15. A control method of an image scanner according to claim 13, further comprising the steps of, when the image data is saved in the portable memory in step (d),
creating the key file anew; and
updating a key file in the past registered in the storing unit and a key file in the past saved in the portable memory with the key file created anew.

16. A control method of an image scanner according to claim 10, further comprising the step of deleting the key file registered in the storing unit on the basis of an instruction from an outside.

17. A control method of an image scanner according to claim 10, wherein, in step (d), the image data is saved in the portable memory and at least a part of contents of the image data and attribute information at the time of the saving are saved in the storing unit.

18. A control method of an image scanner according to claim 10, wherein, in step (d), user authentication is performed when the image data is saved in the portable memory and, when match is determined and the user authentication is successful, the image data is saved in the portable memory.
